(19) United States
(12) Patent Application Publication
(10) Pub. No.: US 2020/0065580 A1
(43) Pub. Date: Feb. 27, 2020

(54) IRIS RECOGNITION SYSTEM FOR FISH

(71) Applicant: Jiwon PARK, Busan (KR)

(72) Inventor: Jiwon PARK, Busan (KR)

(21) Appl. No.: 16/172,199

(22) Filed: Oct. 26, 2018

(30) Foreign Application Priority Data
Aug. 21, 2018 (KR) 10-2018--0097678

(51) Int. Cl. G06K 9/00; G06F 17/30; A01K 29/00

(52) U.S. Cl. CPC G06K 9/00617; G06K 9/00604; G06K 9/0061; A01K 29/00; G06F 17/3028; G06F 17/3089; G06F 17/30876; G06K 9/00362

(57) ABSTRACT

The present invention relates to an iris recognition system for fish, which registers information on fish's iris in a server through the recognition of the fish's iris, and identifies an owner of fish through a matching process of a corresponding server or increases convenience of identification of fish. According to the present invention, an inherent identifier for either proof of ownership of a specific fish or pursuit of a fish to be researched can be easily registered as a fish's iris without suffering an injury to fish through recognition of fish's iris. In addition, by virtue of the registration of the inherent identifier as the fish's iris, the convenience in either proof of the ownership of the specific fish caught by fishermen or pursuit of the to-be-researched fish can be significantly improved while preventing mortality of fish, which is caused by an injury of fish.

### CROSS-REFERENCE TO RELATED APPLICATIONS

This application claims the benefit of Korean Patent Application No. 10-2018-0097678, filed on Aug. 21, 2018 in the Korean Intellectual Property Office, which is incorporated herein by reference in its entirety.

### BACKGROUND OF THE INVENTION

### 1. Field of the Invention

The present invention relates to an iris recognition system for fish, and more particularly, to an iris recognition system for fish, which registers information on fish's iris in a server through the recognition of the fish's iris, and identifies an owner of fish through a matching process of a corresponding server or increases convenience of identification of fish.

### 2. Description of Related Art

In general, a method is employed in which a fish's tail is cut or a chip is inserted into a fish's body in order to conduct researches on fish or represent ownership of fish. However, such a method is not desirable because damage may be caused to fish.

As an example, a fish researcher designates fish to be pursued, and the designated to-be-pursued fish is released back to the sea to perform a research on the fish. However, such a research entails a problem in that a micro chip or a physical mark is required to be inserted into fish in order to perform such a research, and thus damage is caused to the to-be-pursued fish, resulting in mortality of the fish, which makes it difficult to smoothly perform the research on the fish.

As another example, fishermen employ a method of physically hanging a plastic mark indicated with a serial number on fish to prove the ownership of fish caught by them. However, such a method also involves a problem in that this mark suffers an injury to fish, leading to deterioration in the value of fish, and the mark is frequently separated from the fish, causing considerable inconvenience in proof of the ownership of fish.

### PRIOR ART LITERATURE

### Patent Documents

Korean Patent Laid-Open Publication No. 10-2012-0089527

### SUMMARY OF THE INVENTION

The present invention has been made to solve the above-mentioned problems associated with the prior art, and it is an object of the present invention to support registration of fish based on fish's iris to facilitate fish-related studies of fisheries researchers so that researches on fish can be easily performed without suffering an injury to fish.

Another object of the present invention is to allow for fishermen's easy assertion of the proof of the ownership of fish based on iris of fish.

Still another of the present invention is to ensure convenience in identification and recording associated with fish based on iris of fish.

Yet another of the present invention is to support studies on a realm where iris is similarly conserved between species to promote the development of taxonomy.

To achieve the above objects, the present invention provides an iris recognition system for fish, including: an application unit installed in a user terminal, the application unit being configured to acquire an image related to an eye including fish's iris through a camera unit included in the user terminal, generate iris information related to the fish based on analysis of the eye-related image, and generate fish registration information including the iris information based on the fish-related iris information in response to a user's input through a user input unit installed in the user terminal to transmit the generated fish registration information to a preset server, or generate inquiry information including the iris information to transmit the generated inquiry information through a communication unit of the user terminal; and a service server configured to store the fish registration information in a database (DB) included in the service server upon the reception of the fish registration information from the user terminal, compare the iris information included in the inquiry information with iris information included in the fish registration information stored in the DB upon the reception of the inquiry information from the user terminal, extract fish registration information including iris information matching the iris information of the inquiry information from the DB, generate answer information including the extracted fish registration information, and transmit the generated answer information to the user terminal.

### Effects of the Invention

The iris recognition system for fish according to the present invention as constructed above has the following effects.

An inherent identifier for either proof of ownership of a specific fish or pursuit of a fish to be researched can be easily registered as a fish's iris without suffering an injury to fish through recognition of fish's iris. In addition, by virtue of the registration of the inherent identifier as the fish's iris, the convenience in either proof of the ownership of the specific fish caught by fishermen or pursuit of the to-be-researched fish can be significantly improved while preventing mortality of fish, which is caused by an injury of fish.

Further, the use of the present invention enables fisheries research in a more accurate and rapid manner, and fishermen can definitely assert ownership of fish caught by them. In addition, fishermen in the world can simply identify and register fish caught by them through a camera.

In addition, the present invention can contribute the development of taxonomy through studies on a realm where iris is similarly conserved between species.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a diagrammatic view illustrating a configuration of an iris recognition system for fish according to an embodiment of the present invention;

FIG. 2 is a diagrammatic view illustrating an example of the operation of an application unit in an iris recognition system for fish according to an embodiment of the present invention; and

FIG. 3 is a diagrammatic view illustrating an example of the operation of a service server in an iris recognition system for fish according to an embodiment of the present invention.

### EXPLANATION ON SYMBOLS

10: user terminal
11: application unit
100: service server

### DESCRIPTION OF THE PREFERRED EMBODIMENTS

Now, an iris recognition system for fish according to the preferred embodiments of the present invention will be described hereinafter in detail with reference to the accompanying drawings.

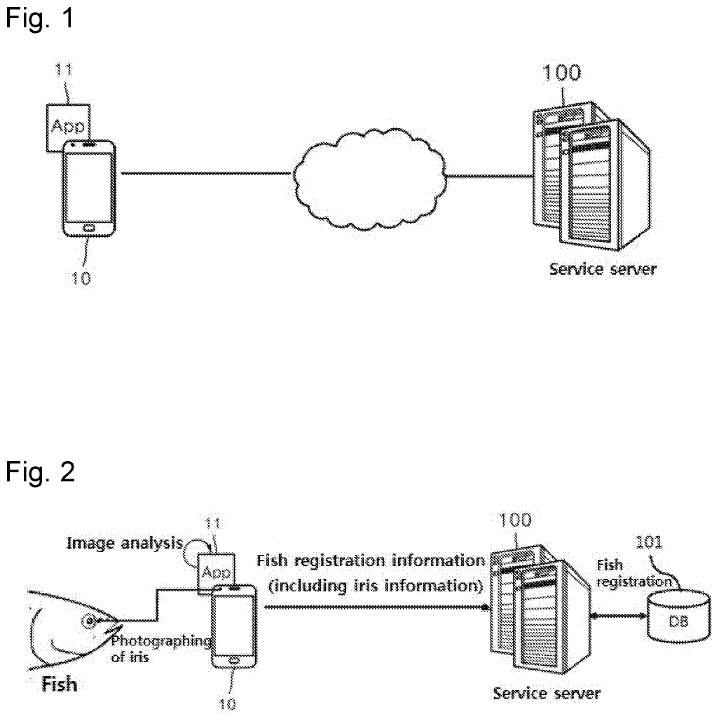

FIG. 1 is a diagrammatic view illustrating a configuration of an iris recognition system for fish according to an embodiment of the present invention,

As shown in FIG. 1, the iris recognition system for fish according to an embodiment of the present invention includes an application unit 11 installed in a user terminal 10 so as to recognize fish's iris and generate fish-related iris information according to the iris recognition and a service server 100 configured to communicate with the user terminal 10 through a communication network.

In this case, the communication network can adopt various wired/wireless communication schemes that are widely known in the art. Examples of the wired/wireless communication schemes include a wireless communication scheme such as wireless LAN (WLAN), digital living network alliance (DLNA), wireless broadband (Wibro), world interoperability for microwave access (Wimax), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), IEEE 802.16, long term evolution (LTE), long term evolution-advanced (LTE-A), wireless mobile broadband service (WMBS), Bluetooth, radio frequency identification (RFID), Infrared Data Association (IrDA), ultra wideband (UWB), ZigBee, near field communication (NFC), ultra sound communication (USC), visible light communication (VLC), Wi-Fi, Wi-Fi Direct, and the like, and a wired communication scheme such as power line communication (PLC), USB communication, Ethernet, serial communication, optical and axial cables, and the like.

In addition, the user terminal 10 described herein may include various terminals such as a smartphone including a communication function, a portable terminal, a mobile terminal, a personal digital assistant (PDA), a personal computer, a notebook computer, a slate PC, a tablet PC, an ultrabook, a wearable device (for example, including a watch-type terminal (a smartwatch), a glass terminal (a smart glass), a head mounted display (HMD) or the like), a WiBro terminal, an Internet protocol television (IPTV) terminal, a smart TV, a digital broadcasting terminal, an audio video navigation (AVN) terminal, an audio/video (A/V) system, a flexible terminal, and the like.

In addition, the user terminal 10 may include the application unit 11. The application unit 11 is stored in a storage unit of the user terminal 10 and is configured as a control unit that executes an application including an algorithm for recognizing fish's iris and an algorithm necessary for operating the application unit 11 according to its communication with the service server 100.

In this case, the control unit performs the overall control function of the user terminal 10 using a program and data stored in the storage unit of the user terminal 10. The control unit may include an RAM, an ROM, a CPU, a GPU, and a bus. The RAM, ROM, CPU, and GPU can be connected to each other through the bus. The CPU can access the storage unit to perform a booting operation using an operating system (O/S) stored in the storage unit. In addition, the CPU can perform various operations described herein while being operated as the application unit 11 using various programs, contents, data and the like, which are stored in the storage unit.

Further, the user terminal 10 may include, in addition to the application unit 11, various constituent elements such as a camera unit configured to photograph the fish's iris to generate an iris-related image, a communication unit configured to perform a communication with the service server 100 through a communication network, a display unit configured to display various items of information, a storage unit configured to store various data including application-related data, and a user input unit configured to receive a user's input. The application unit 11 may control the constituent elements that constitute the user terminal.

Based on the above-described configuration, the present invention allows iris information obtained by photographing fish's eye through the user terminal 10 to be included fish registration information for registration of the fish in the service server 100 so that the fish can be conveniently identified and registered, and simultaneously allows the user terminal 10 to generate inquiry information necessary for either proof of the ownership of a specific fish or pursuit of a fish to be researched based on the iris information and transmit the generated inquiry information to the service server 100, and allows the service server 100 to support either proof of ownership of the specific fish inquired by a user or identification of the to-be-researched fish based on the inquiry information while supporting an identification record for the specific fish based on the fish registration information, thereby increasing convenience in proof of the ownership of fish and pursuit/identification of the to-be-researched fish without suffering an injury to fish.

Hereinafter, a detailed operation and configuration of the present invention will be described in detail with reference to the accompanying drawings.

First, FIG. 2 is a diagrammatic view illustrating an example of the operation of the application unit 11 installed in the user terminal 10 in an iris recognition system for fish according to an embodiment of the present invention.

As shown in FIG. 2, the application unit 11 installed in the user terminal 10 can photograph a specific fish's eye through the camera unit of the user terminal 10 and acquire an image related to an eye including the specific fish's iris.

In addition, the application unit 11 can generate iris information related to the fish based on analysis of the eye-related image.

In this case, fish's iris is free from a fibrous layer having a stereoscopic depth unlike a person, and thus it cannot be recognized by a general human iris recognition method.

Accordingly, the application unit 11 can recognize a specific fish's inherent iris according to a preset inherent iris recognition algorithm that is related to fish

As an example, the application unit 11 can extract or calculate a feature point parameter depending on a preset attribute including at least one of a pattern of a pupil or a crystalline lens, an arrangement pattern of one or more points existing in a specific fish's iris, an arrangement correlation between the pupil or the crystalline lens and the points, and a color of the iris through analysis of an eye-related image acquired by photographing the specific fish's eye through the camera unit according to the iris recognition algorithm.

In addition, the application unit 11 can generate information on the specific fish's iris including the attribute-dependent feature point parameter.

Further, the application unit 11 can generate either fish registration information including the iris information necessary for registering the specific fish in the service server 100 in response to a user's input through the user input unit of the user terminal 10, or inquiry information including iris information of the specific fish necessary for inquiring ownership of the specific fish or determining whether or not the specific fish is a fish to be researched.

In this case, the application unit 11 of the user terminal 10 can access a webpage of a website provided by the service server 100 through the communication unit of the user terminal 10.

In addition, the service server 100 can transmit webpage-related data for generation of the fish registration information or the inquiry information to the user terminal 10 in response to the access of the user terminal 10 to the website.

By virtue of this operation of the service server 100, the application unit 11 of the user terminal 10 can display a webpage for registration of fish or inquiry of a specific fish through the display unit of the user terminal 10 based on the webpage-related data transmitted thereto from the service server 100, and generate the fish registration information or the inquiry information based on the user's input through the webpage.

In this case, the application unit 11 may include, in addition to the iris information, a unique identification number of the specific fish, information on an owner of the specific fish, additional information including at least one of weight, length and color of the specific fish, and information on taxonomic species related to the specific fish, in association with the specific fish based on the user's input through the user input unit, in the fish registration information.

In addition, the application unit 11 can transmit the fish registration information or the inquiry information to the service server 100 through the communication unit of the user terminal 10.

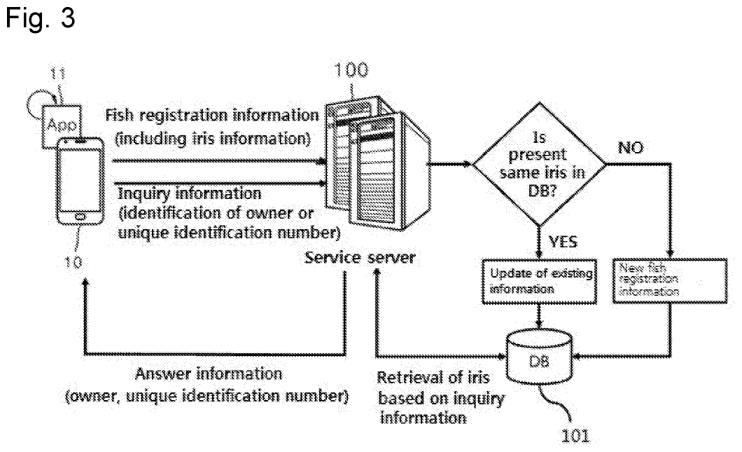

In the meantime, FIG. 3 is a diagrammatic view illustrating an example of the operation of the service server 100 in an iris recognition system for fish according to an embodiment of the present invention.

As shown in FIG. 3, the service server 100 can store the fish registration information in a database (DB) 101 included in the service server 100 upon the reception of the fish registration information from the user terminal 10, and can store fish registration information related to the specific fish requested by the user in the DB 101 to register the specific fish.

In this case, if existing fish registration information including the same iris information as iris information included in the fish registration information related to the specific fish requested by the user is present in the DB 101, the service server 100 can update the existing fish registration information based on the fish registration information.

On the contrary, if existing fish registration information including iris information matching iris information included in the fish registration information related to the specific fish requested by the user is not present in the DB 101, the service server 100 can register the fish registration information as new fish registration information.

In the meantime, the service server 100 can compare the iris information included in the inquiry information with iris information included in the fish registration information stored in the DB 101 upon the reception of the inquiry information from the user terminal 10.

In other words, the service server 100 can extract the iris information from the inquiry information for comparison with the iris information included in the fish registration information stored in the DB 101.

In addition, the service server 100 can compare the iris information included in the inquiry information with iris information included in the fish registration information stored in the DB 101 upon the reception of the inquiry information from the user terminal 10, and extract fish registration information including iris information matching the iris information of the inquiry information from the DB 101.

Besides, the service server 100 can generate answer information based on the fish registration information extracted from the DB 101 correspondingly to the inquiry information, and transmit the generated answer information to the user terminal 10.

In other words, the service server 100 can generate answer information corresponding to the inquiry information, including an owner, a unique identification number, or an additional information corresponding to a specific fish in response to an inquiry related to a request for the unique identification number or the additional information for inquiring the owner of the specific fish or pursuing a fish to be researched, and transmit the generated answer information to the user terminal 10.

In this case, the service server 100 may transmit, as the answer information, the fish registration information extracted from the DB 101 correspondingly to the inquiry information to the user terminal 10.

Meanwhile, the application unit 11 of the user terminal 10 can display the answer information transmitted thereto from the service server 100 correspondingly to the inquiry information through the display unit of the user terminal 10.

By virtue of this configuration, the present invention can provide an answer to identification of an owner of a specific fish, proof of the ownership of the specific fish, and pursuit and identification of the specific fish to be researched in association with the specific fish inquired by the user through the photographing of the specific fish.

In the meantime, the user terminal 10 according to an embodiment of the present invention may be configured as a portable device enabling iris recognition.

In addition, in the case where the application unit 11 is configured as an accessory device such as an USB that performs a function and is communicatively connected to the user terminal 10 such as a smartphone, a PC or the like, it may be operated in cooperation with the user terminal 10 as described above.

As described above, according to the present invention, an inherent identifier for either proof of ownership of a specific fish or pursuit of a fish to be researched can be easily registered as a fish's iris without suffering an injury to fish through recognition of fish's iris. In addition, by virtue of the registration of the inherent identifier as the fish's iris, the convenience in either proof of the ownership of the specific fish caught by fishermen or pursuit of the to-be-researched fish can be significantly improved while preventing mortality of fish, which is caused by an injury of fish.

Further, the use of the present invention enables fisheries research in a more accurate and rapid manner, and fishermen can definitely assert ownership of fish caught by them. In addition, fishermen in the world can simply identify and register fish caught by them through a camera.

In addition, the present invention can contribute the development of taxonomy through studies on a realm where iris is similarly conserved between species.

Various devices and constituent elements described herein can be implemented by a hardware circuit (e.g., CMOS-based logic circuit), a firmware, a software, or combinations thereof. For example, the devices and constituent elements can be implemented by using a transistor, a logic gate, and an electronic circuit in the form of various electrical structures.

While the iris recognition system for fish of the present invention has been described in connection with the exemplary embodiments illustrated in the drawings, they are merely illustrative and the invention is not limited to these embodiments. It will be appreciated by a person having an ordinary skill in the art that various equivalent modifications, variations, and substitutions of the embodiments can be made without departing from the spirit and scope of the present invention. Therefore, the true technical scope of the present invention should be defined by the appended claims, and all the technical spirits falling within the scope equivalent to the technical scope should be construed to be included in the right scope of the invention.

What is claimed is:

1. An iris recognition system for fish, comprising:
an application unit installed in a user terminal, the application unit being configured to acquire an image related to an eye including fish's iris through a camera unit included in the user terminal, generate iris information related to the fish based on analysis of the eye-related image, and generate fish registration information including the iris information based on the fish-related iris information in response to a user's input through a user input unit installed in the user terminal to transmit the generated fish registration information to a preset server, or generate inquiry information including the iris information to transmit the generated inquiry information through a communication unit of the user terminal; and
a service server configured to store the fish registration information in a database (DB) included in the service server upon the reception of the fish registration information from the user terminal, compare the iris information included in the inquiry information with iris information included in the fish registration information stored in the DB upon the reception of the inquiry information from the user terminal, extract fish registration information including iris information matching the iris information of the inquiry information from the DB, generate answer information including the extracted fish registration information, and transmit the generated answer information to the user terminal.

2. The iris recognition system for fish according to claim 1, wherein the application unit calculates a feature point parameter depending on a preset attribute including at least one of a pattern of a pupil or a crystalline lens, an arrangement pattern of one or more points existing in a fish's iris, an arrangement correlation between the pupil or the crystalline lens and the points, and a color of the iris through analysis of the eye-related image acquired by photographing the fish's eye through the camera unit, and generates iris information including the attribute-dependent feature point parameter.

3. The iris recognition system for fish according to claim 1, wherein the service server transmits webpage-related data for registration of the fish's iris to the user terminal, and the application unit of the user terminal displays a webpage for registration of fish based on the webpage-related data, and generates the fish registration information or the inquiry information through the webpage for transmission to the service server.

4. The iris recognition system for fish according to claim 1, wherein the fish registration information comprises a unique identification number of the fish, information on an owner of the fish, additional information including at least one of weight, length and color of the fish, and information on taxonomic species related to the fish.

5. The iris recognition system for fish according to claim 1, wherein the service server provides, to the user terminal, an identification number related to either a fish to be researched or an owner of fish corresponding to the inquiry information through the answer information if fish registration information matching iris information of the inquiry information is present upon the reception of the inquiry information from the user terminal.
